(19) United States
(12) Patent Application Publication
(10) Pub. No.: US 2026/0367964 A1
(43) Pub. Date: Nov. 19, 2026

(54) METHOD FOR CHECKPOINTING, MIGRATING, AND RESUMING A PROCESS IN A CLOUD COMPUTING ENVIRONMENT

(71) Applicant: Cedana AI Inc., New York, NY (US)

(72) Inventors: William Foy, New York, NY (US); Neel Master, Santa Monica, CA (US); Brandon Smith, Wichita, KS (US); Niranjan Ravichandra, Washington, DC (US)

(21) Appl. No.: 18/957,400

(22) Filed: Nov. 22, 2024

Related U.S. Application Data
(60) Provisional application No. 63/603,795, filed on Nov. 29, 2023.
(60) Provisional application No. 63/557,977, filed on Feb. 26, 2024.
(60) Provisional application No. 63/705,935, filed on Oct. 10, 2024.

(51) Int. Cl. G06F 9/48; G06F 9/50

(52) U.S. Cl. CPC G06F 9/4875; G06F 9/5038

(57) ABSTRACT

A method includes: in response to receiving a checkpoint command, recording a state of a process executing at a first node, the state representing resources in the first node allocated to the first process at a first time and including a set of data stored in a first memory of the first node; generating a checkpoint object representing the state of the first process at the first time; transmitting the checkpoint object to the checkpoint server; accessing the first checkpoint object from the checkpoint server by a second checkpoint program; extracting the first set of data from the first checkpoint object; and restoring the first state of the first process at the second node by loading the first set of data into a second memory of the second node for execution of the first process.

### CROSS-REFERENCE TO RELATED APPLICATIONS

This application claims the benefit of U.S. Provisional Application No. 63/705,935, filed on 10 Oct. 2024, U.S. Provisional Application No. 63/557,977, filed on 26 Feb. 2024, and U.S. Provisional Application No. 63/603,795, filed on 29 Nov. 2023, each of which is incorporated in its entirety by this reference.

### TECHNICAL FIELD

This invention relates generally to the cloud computing and more specifically to a new and useful method for checkpointing, migrating, and resuming a process in a cloud computing environment within the field of cloud computing.

### BRIEF DESCRIPTION OF THE FIGURES

FIG. 1 is a flowchart representation of a method;

FIGS. 2A, 2B, and 2C are flowchart representations of one variation of the method;

FIG. 3 is a flowchart representation of one variation of the method; and

FIG. 4 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. METHODS

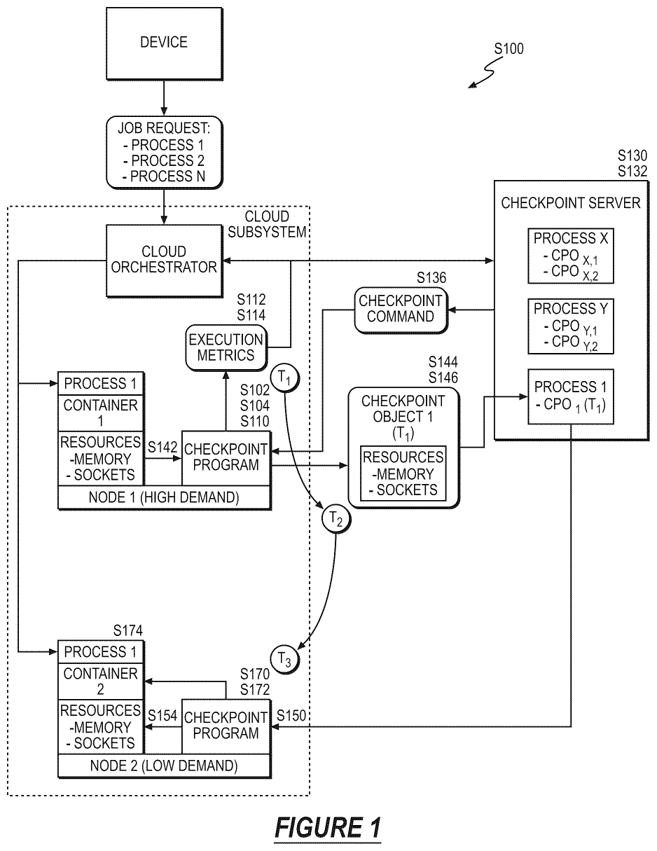

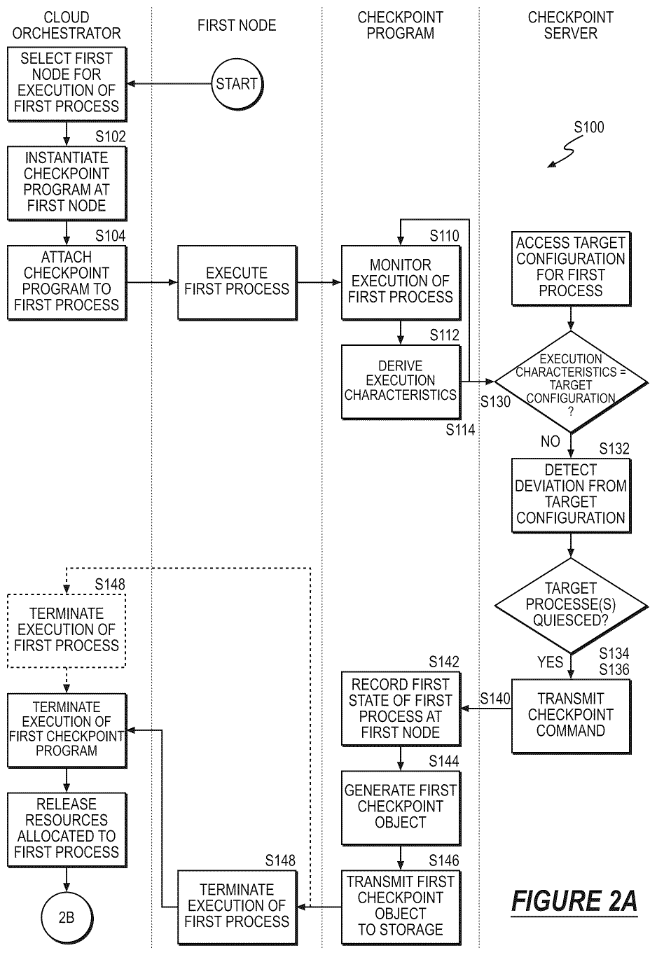

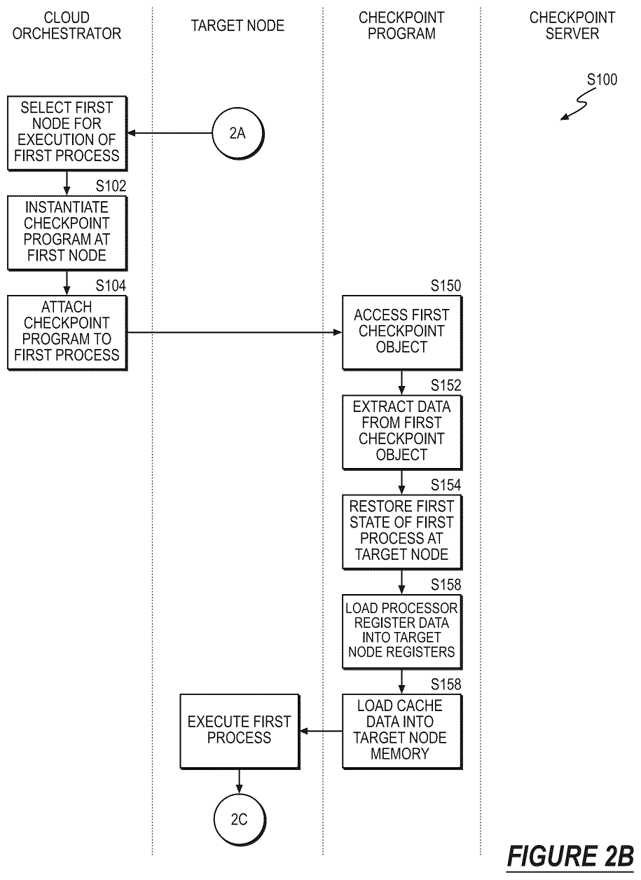

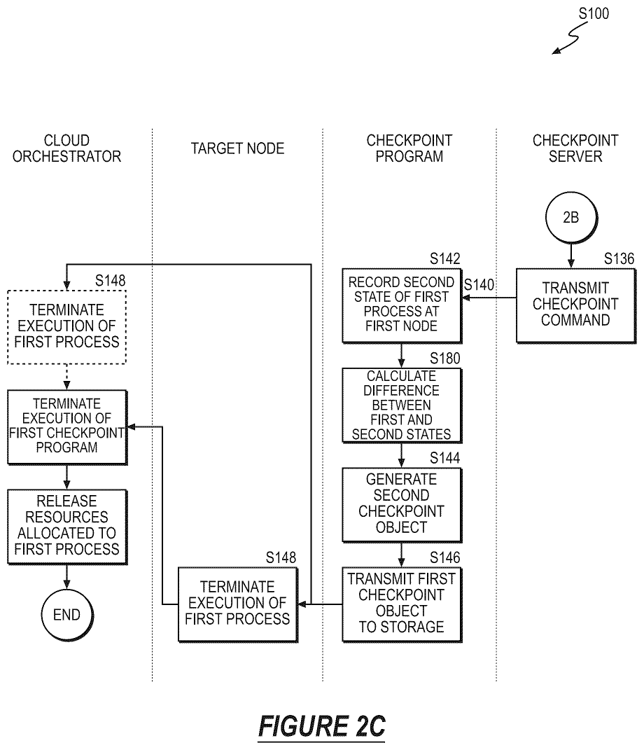

As shown in FIGS. 1, 2A, and 2B, a method S100 includes, during a first time period, at a first checkpoint program executing at a first node, in response to receiving a first checkpoint command from a checkpoint server: recording a first state of a first process executing at the first node in Block S142; generating a first checkpoint object representing the first state of the first process at the first time in Block S144; and transmitting the first checkpoint object to the checkpoint server in Block S146. The first state: represents a first set of resources in the first node allocated to the first process at a first time; includes a first set of data stored in a first set of processor registers in the first set of resources; and includes a second set of data stored in a first memory device in the first set of resources.

The method S100 further includes, during the first time period, terminating execution of the first process and the first checkpoint program at the first node in Block S148.

The method S100 also includes, during a second time period succeeding the first time period, at a second checkpoint program executing at a second node: accessing the first checkpoint object from the checkpoint server in Block S150; extracting the first set of data and the second set of data from the first checkpoint object in Block S152; restoring the first state of the first process at the second node in Block S154 by loading the first set of data into a second set of processor registers in the second node in Block S156 and loading the second set of data into a second memory device in the second node in Block S158.

The method S100 further includes, during the second time period, resuming the first process at the second node based on the first set of data loaded into the second set of processor registers and the second set of data loaded into the second memory device in Block S174.

### 1.1 Variation: Container Checkpointing and Resumption

As shown in FIGS. 1, 2A, and 2B, one variation of the method S100 includes, during a first time period, at a first checkpoint program executing at a first node: deriving a set of execution characteristics representing resources in the first node allocated to a first process during execution of the first process within a first container instantiated at the first node in Block S112; and transmitting the set of execution characteristics to the checkpoint server in Block S14.

This variation of the method S100 also includes, during the first time period, at the checkpoint server: in response to receiving the set of execution characteristics at the checkpoint server, detecting a difference between the set of execution characteristics and a target configuration for the first process in Block S132; and transmitting a first checkpoint command to the first checkpoint program in response to detecting the difference in Block S136.

This variation of the method S100 further includes, at the first checkpoint program in response to receiving the first checkpoint command from a checkpoint server: recording a first state of the first process executing within the first container at the first node, the first state representing a first set of resources in the first node assigned to the first container and allocated to the first process at a first time and including a first set of data stored in a first memory in the first set of resources in Block S142; generating a first checkpoint object representing the first state of the first process at the first time in Block S144; and transmitting the first checkpoint object to the checkpoint server in Block S146.

This variation of the method S100 also includes, during a second time period succeeding the first time period, at a second checkpoint program executing at a second node: accessing the first checkpoint object from the checkpoint server in Block S150; extracting the first set of data from the first checkpoint object in Block S152; restoring the first state of the first process at the second node by loading the first set of data into a second memory in the second node for execution of the first process within a second container instantiated at the second node in Block S154; generating a message triggering resumption of the first process within the second container in Block S170; and transmitting the message to a container manager executing at the second node in Block S172.

### 1.2 Variation: Graphics Processing Unit Checkpointing

As shown in FIGS. 1, 2A, and 3, one variation of the method S100 includes, at a first checkpoint program executing at a first node during a first time period: intercepting a first call in a set of calls to a first application programming interface of a first graphics processing unit in the first node by a first process executing at the first node in Block S120; detecting a first subset of memory operations, associated with the first call, in a first set of memory operations associated with the first graphics processing unit in Block S122; and generating a first call record, in a set of call records, representing the first call and the first subset of memory operations in Block S124.

This variation of the method S100 also includes, in response to a checkpoint command from a checkpoint server: recording a first state of the first process executing at the first node in Block S142; generating a first checkpoint object representing the first state of the first process at the first time in Block S144; and transmitting the first checkpoint object to the checkpoint server in Block S146. The first state: represents a first set of resources in the first node allocated to the first process at a first time; includes a first set of data stored in a first memory in the first set of resources; and represents the set of call records at the first time.

### 1.3 Variation: Automatic Suspension and Resumption

As shown in FIGS. 1, 2A, and 2B, one variation of the method S100 includes, during a first time period, at a first checkpoint program executing on a first node: monitoring execution of a first process, in a set of processes representing a job, on the first node in Block S110; generating a set of execution characteristics representing a set of resources allocated to the first process during execution in Block S112; and transmitting the set of execution characteristics to a cloud orchestrator and a checkpoint server in Block S114.

The method S100 also includes, in response to receiving a checkpoint command from the checkpoint server: recording a first state, of the first process, represented by the set of resources of the first node allocated to the first process at a first time in Block S142; generating a first checkpoint object representing the first state of the first process at the first time in Block S144; and transmitting the first checkpoint object to the checkpoint server in Block S146.

The method S100 further includes, during a second time period succeeding the first time period, at a second checkpoint program executing on a second node: accessing the first checkpoint object from the checkpoint server in Block S150; and restoring the first state of the first process on resources of the second node in Block S154.

### 2. APPLICATIONS

Generally, a computer system (hereinafter “the system”)—including or interfacing with a cloud infrastructure and/or a checkpoint server—can execute Blocks of the method S100: to receive a job (e.g., an inference job, a training job) from a device (e.g., a user device, an enterprise device); to generate a first workload instance on a first node of the cloud infrastructure; to deploy a checkpoint program and a process of the job onto the first workload instance; to monitor execution of the process at the first node via the checkpoint program; to suspend execution of the process at a target time; and to checkpoint the process at the target time.

More specifically, the system can execute Blocks of the method S100: to detect resources of the node allocated to the process at the target time; to record a state of the process representing these resources via the checkpoint program; to generate a checkpoint object representing the state of the process of the target time; to store the checkpoint object at a checkpoint server; and to terminate the first workload instance at the first node.

At a future time, the system can execute Blocks of the method S100: to generate a second workload instance on a second node of the cloud infrastructure; to access the checkpoint object representing the state of the process of the target time; to deploy the checkpoint program, the first process, and the checkpoint object on the second workload instance; to restore the state of the process on resources of the second node; and to resume execution of the process.

Accordingly, the system can execute Blocks of the method S100: to checkpoint a state of a process executing at a first node in the cloud infrastructure—without modification to the process—by identifying resources of the node allocated to the workload instance; to migrate the process to a second node in the cloud infrastructure; and to resume execution of the process by restoring the state onto resources of the second node. Therefore, the system can extend fine-grained (e.g., near-real-time) suspension, checkpointing, and resumption functionality: to existing processes without modification thereto; and/or to existing cloud infrastructures while preserving deployment and security workflows of these cloud infrastructures.

### 2.1 Graphics Processing Unit Process Migrations

Additionally, the system can execute Blocks of the method S100: to track a sequence of calls (e.g., memory operations) by a process to an application programming interface of a first graphics processing unit(s) in the first node during execution of the process on the first workload instance at the first node via the checkpoint program; and to record the sequence of calls in the checkpoint object representing the state of the process at a target time.

At a future time, the system can execute Blocks of the method S100: to restore the state of the process onto resources of a second node by sequentially executing the sequence of calls to a second graphics processing unit(s) in the second node; and to resume execution of the process.

Therefore, by recording a sequence of calls by the process to a graphics processing unit of the first node, the system can execute Blocks of the method S100 to later execute (or “replay”) this sequence of calls at the second node in order to restore the state of the graphics processing unit while maintaining coherency of execution absent modification to the process and/or the workloads.

### 2.1 Example: Demand-Based Migration

In one example application, the system executes Blocks of the method S100: to select a first node—located in a first region in the cloud infrastructure—based on a first cost of resources of the first node at a first time in the first time period; to deploy a first process onto the first node; and to execute the first process at the first node.

Then, the system executes Blocks of the method S100: to access a first demand (e.g., an increased demand) in the first region at a second time succeeding the first time; to identify a second cost of resources of the first node based on the first demand in the first region at the second time; to access a second demand (e.g., a reduced demand) in a second region in the cloud infrastructure at the second time; and to identify a third cost of resources of a second node—located in the second region—based on the second demand (e.g., the third cost of resources falling below the second cost of resources).

In response to the second cost of resources of the first node exceeding a cost threshold defined in a service level agreement, the system executes Blocks of the method S100: to checkpoint a state of the first process at the first node; to select the second node located in the second region based on the third cost of resources of the second node falling below the cost threshold and/or the second cost of resources of the first node; to migrate the first process to the second node; and to resume execution of the first process by restoring the state of the first process onto resources of the second node.

Accordingly, the system can execute Blocks of the method S100: to migrate workloads to different regions of the cloud infrastructure—without modification to the workloads—based on cost, requirements, and/or availability of resources to execute these workloads. Therefore, the system can selectively suspend and resume execution of a workload based on time-varying cost of resources, thereby reducing a total cost to complete a job while maintaining service level agreements.

### 3. TERMINOLOGY

Generally, a “job” is referred to herein as a first unit of work—received from a device—including a set of processes for execution.

Generally, a “process” is referred to herein as an instance of a program represented by a memory space, a file descriptor, and/or a unique process identifier (or “PID”).

Generally, a “program” is referred to herein as set of instructions executable by a computer.

Generally, a “container” is referred to herein as an isolated runtime environment.

Generally, “checkpoint” is referred to herein as recording a state of a set of resources allocated to (or utilized by) a process executing on a node.

Generally, “cloud infrastructure” is referred to herein as a remote contract computing network.

### 4. SYSTEM

Generally, as shown in FIG. 1, the system can include and/or interface with: a device (e.g., a user device, an enterprise device); a cloud computing subsystem (hereinafter “the cloud subsystem”) communicatively coupled to the device via a communication network (e.g., e.g., a local area network, a wide area network, the Internet); and a checkpoint server communicatively coupled to the cloud subsystem via the communication network.

The system can include additional devices communicatively coupled to the cloud subsystem via the communication network.

### 4.1 Cloud Subsystem

Generally, the cloud subsystem can include or interface with: a set of nodes (e.g., computing devices, bare-metal servers); and a cloud orchestrator (e.g., a computing device).

In one example, the set of nodes includes: a first subset of nodes located in a first geographic region (e.g., a first country); and a second subset of nodes located in a second geographic region (e.g., a second country).

In another example, the set of nodes includes: a first subset of nodes in a first computer network (e.g., a first network fabric); and a second subset of nodes in a second computer network (e.g., a second network fabric) different from the first computer network.

In one implementation, the cloud subsystem receives a request—from the device—to execute a job (e.g., an inference job, a training job, a rendering job, a gaming application) including a set of processes. In response to receiving the request, the cloud subsystem: executes the job; and returns a result to the device (or queues the result for download).

More specifically, the cloud orchestrator can: receive the job from the device; and schedule execution of a first process—in the set of processes—at a first node in the set of nodes. The first node can then execute the first process. For each process in the set of processes, the cloud subsystem can repeat the foregoing methods and techniques: to schedule execution of the process at a node (e.g., the first node, a second node) in the set of nodes; and to execute the process at the node.

The cloud subsystem can return a result to the device (or queue the result for download) in response to completion of the job.

### 4.1.1 Resource Cost

In one implementation, the cloud orchestrator can calculate a total cost attributed to execution of the first process on resources of the node.

For example, the cloud orchestrator can calculate the total cost based on: an amount of resources (e.g., processing capacity, memory capacity, I/O bandwidth, execution time) in the node allocated to the first process; and a cost of resources of the node based on demand and/or locality of the node.

### 4.2 Checkpoint Program

In one implementation, the system includes a checkpoint program (or a “daemon”) executing at a node in the set of nodes. For example, the node can execute the checkpoint program as a background process.

In another implementation, the checkpoint program: instantiates (or executes) at a node in the set of nodes; attaches to a process executing at the node; and monitors execution of the process at the node.

For example, the checkpoint program can: generate a set of execution characteristics representing resources allocated to the process during execution; and transmit the set of execution characteristics to the cloud orchestrator and/or the checkpoint server.

In this implementation, in response to receiving a checkpoint command (e.g., a remote procedure call), the checkpoint program: records state information associated with the process (or a “process state”); generates a checkpoint object representing the state information; and transmits the checkpoint object to the checkpoint server.

### 4.3 Checkpoint Server

Generally, the checkpoint server stores a set of checkpoint objects, each checkpoint object associated with a process in a set of processes. More specifically, the checkpoint server can store a group of checkpoint objects associated with a process in a set of processes representing a job.

In one implementation, the checkpoint server includes a data repository storing the set of checkpoint objects.

Additionally or alternatively, the checkpoint server can store the set of checkpoint objects in an external data repository (e.g., a remote data repository).

In another implementation, the checkpoint server communicates with a checkpoint program executing on a node. For example, the checkpoint server can transmit commands (e.g., remote procedure calls) to a checkpoint program executing at a node, such as: a first command to record a state of a process executing at the node as a checkpoint object; and a second command to restore the state of the process—extracted from the checkpoint object stored at the checkpoint server—at a target node.

### 5. PROCESS CHECKPOINTING

The method S100 includes, at a first checkpoint program executing at a first node, in response to receiving a first checkpoint command from a checkpoint server: recording a first state of the first process executing at the first node, the first state representing a first set of resources in the first node allocated to the first process at a first time in Block S142; generating a first checkpoint object representing the first state of the first process at the first time in Block S144; and transmitting the first checkpoint object to the checkpoint server in Block S146.

Block S148 recites terminating execution of the first process and the first checkpoint program at the first node.

Generally, as shown in FIG. 2A and in Blocks S110, S142, S144, and 146, the system can: execute a process of a job at a node; monitor execution of the process at the node; record a state of the process in response to a checkpoint command; generate a checkpoint object representing the state of the process; and store the checkpoint object at the checkpoint server.

In one implementation, the cloud subsystem: selects a first process in a set of processes of a job received from the device; identifies a first node—in the set of nodes—at which to schedule the first process; instantiates (or executes) the checkpoint program at the first node; allocates resources in the first node to the first process; schedules execution of the first process at the first node; and executes the first process at the first node.

In one implementation, the checkpoint program: monitors execution of the first process at the first node in Block S110; derives a set of execution characteristics representing resources of the first node allocated to the first process (e.g., processor utilization, memory utilization, data storage throughput, network throughput) in Block S112; and transmits the set of execution characteristics to the cloud orchestrator and/or the checkpoint server in Block S114.

In another implementation, in Block S136, the checkpoint server serves a command (or a “checkpoint command”)—to the checkpoint program—to checkpoint the first process, such as in response to detecting the set of execution characteristics representing idle resources allocated to the first process.

In response to receiving the command to checkpoint the first process, the checkpoint program: records a first state of the first process executing on the first node in Block S142; generates a first checkpoint object representing the first state of the first process in Block S144; and transmits the first checkpoint object to the checkpoint server in Block S146.

In response to checkpointing the first process, the first node can continue executing the first process. Alternatively, the cloud orchestrator can: terminate execution of the first process (and the checkpoint program) at the first node in Block S148; and release the resources allocated to the first process.

In one implementation, the checkpoint server: receives the first checkpoint object from the checkpoint program; associates the checkpoint object with a first process identifier (or “PID”) identifying the first process; and stores the first checkpoint object, in a group of checkpoint objects associated with the first process identifier, in a data repository.

Accordingly, the system can: detect node resources allocated to a process during execution; record a current state of the process in response to these node resources representing an idle state of the process; generate a checkpoint object representing the current state of the process; store the checkpoint object for later retrieval and resumption of the process from the current state; and release the node resources allocated to the process. Therefore, the system can automatically suspend the process in real-time (or near-real-time)—without modification to the process—for resumption at a different node and/or at a later time, thereby enabling more efficient allocation of node resources and/or reducing a total cost of completing the job received from the device.

### 5.1 Process Scheduling and Execution

The method S100 includes: instantiating the first checkpoint program at the first node, the first checkpoint program characterized as background process executing at the first node in Block S102; and attaching the first checkpoint program to the first process identified by a first process identifier in Block S104.

In one implementation, the cloud orchestrator: selects the first node—in the set of nodes—at which to schedule the first process of the job; and allocates resources in the first node to the first process.

For example, the cloud orchestrator can select the first node based on: a policy (e.g., a service level agreement) associated with the job and defining a target configuration (e.g., resource parameters, price parameters, cost parameters) for the first process; resource availability on the first node; and/or a current cost of resources at the first node. Then, the cloud orchestrator: instantiates the first process and the checkpoint program at the first node in Block S102; attaches the checkpoint program to the first process in Block S104; and schedules execution of the first process at the first node.

More specifically, the cloud orchestrator (or the first node) can: instantiate the checkpoint program as a background process executing at the first node; and attach the first checkpoint program to the first process identified by the first process identifier.

In another implementation, the checkpoint program queries the checkpoint server for a checkpoint object associated with the first process. For example, the checkpoint program can transmit a first message requesting a checkpoint object associated with the first process identifier. In this example, the checkpoint server can transmit a second message indicating absence of a checkpoint object associated with the first process identifier.

The first node can then execute the first process.

### 5.1.1 Target Configuration

Generally, the system can access a policy—associated with a job (or a set of jobs)—specifying rules for deployment and execution of the job within the cloud subsystem.

More specifically, the cloud orchestrator and/or the checkpoint server can access the policy defining a target configuration for the job and/or for a process (e.g., the first process) of the job. The target configuration can represent a set of parameters (e.g., resource parameters, price parameters, cost parameters) for executing the process.

In one implementation, the system can access the policy defining a target configuration representing a set of parameters—corresponding to a set of target performance characteristics and representing orchestration rules for the job—such as: central processing unit processing capacity; central processing unit throughput; central processing unit utilization; central processing unit type; graphics processing unit processing capacity; graphics processing throughput; graphics processing unit utilization; graphics processing type; processor interconnect; memory capacity (e.g., size, bandwidth); memory type; memory throughput; network interconnect; network bandwidth; network throughput; error rate; storage capacity; availability; latency; response time; locality (e.g., region, country); security features (e.g., encryption, hardware security module); regulatory features (e.g., privacy compliance); price (e.g., node spot price, node projected price, storage price); egress fee; and/or total cost; etc. The system can access the policy defining a set of values (e.g., a target value, a maximum value, a minimum value, an average value) for each parameter in the set of parameters. Additionally, the system can access the policy defining a rank (or a priority) for each parameter in the set of parameters.

In another implementation, the cloud subsystem: accesses performance characteristics (e.g., real-time performance characteristics) of the set of nodes; and selects the first node at which to schedule the first process in response to correspondence between a first set of performance characteristics of the first node and the target configuration for the first process.

For example, the cloud subsystem can: access the target configuration corresponding to a set of target performance characteristics; access the first set of performance characteristics of the first node; and select the first node in response to the first set of performance characteristics falling within the set of target performance characteristics.

### 5.1.2 Workload Monitoring

The method S100 includes: deriving a set of execution characteristics representing resources in the first node allocated to the first process during execution in Block S112; transmitting the set of execution characteristics to the checkpoint server in Block S114.

In one implementation, in Block S110, the checkpoint program monitors execution of the first process at the first node.

More specifically, the checkpoint program can monitor (or track) the set of resources allocated to the first process at a target time during execution according to the first process identifier. For example, the checkpoint program can monitor the set of resources allocated to the first process during execution by querying a control program (e.g., a host kernel, a guest kernel, a container manager) for resources associated with the first process identifier at the target time.

In another implementation, the checkpoint program derives a set of execution characteristics representing resources allocated to the first process during execution in Block S12. For example, the checkpoint program can derive the set of execution characteristics representing: a current processor utilization attributed to execution of (or allocated to) the first process; and/or a current network throughput attributed to execution of the first process. The checkpoint program transmits the set of execution metrics to the cloud orchestrator and/or the checkpoint server in Block S114.

The checkpoint program can periodically generate and transmit a set of execution characteristics according to a predefined frequency (e.g., once per second, once per ten seconds, once per minute).

### 5.2 Checkpoint Command

The method S100 includes: receiving the set of execution characteristics from the first checkpoint program in Block S130, the set of execution characteristics representing a first processor utilization by the first process at a target time; detecting the quiescent state of the first process in response to the first processor utilization falling below a threshold processor utilization in Block S132; and transmitting the checkpoint command to the first checkpoint program in response to detecting the quiescent state of the first process in Block S136.

One variation of the method S100 includes: in response to receiving the set of execution characteristics at the checkpoint server, detecting a difference between the set of execution characteristics and a target configuration for the first process in Block S132; and transmitting a first checkpoint command to the first checkpoint program in response to detecting the difference in Block S136.

Generally, in Block S136, the checkpoint server can transmit a checkpoint command to the checkpoint program executing at the first node.

In one implementation, in Block S136, the checkpoint server transmits the checkpoint command based on a schedule—associated with the first process—defining a frequency (e.g., once per ten seconds, once per minute, once per hour) at which to transmit a checkpoint command to the checkpoint program.

In another implementation, the checkpoint server: receives a request—from the cloud orchestrator—to suspend execution of the first process at the first node (e.g., in response to receiving a second request from the device); and transmits the checkpoint command to the checkpoint program in response to the first request in Block S136.

In another implementation, the checkpoint server: receives a set of execution characteristics from the checkpoint program in Block S130; and transmits the checkpoint command based on the set of execution metrics in Block S136.

More specifically, the checkpoint server can: detect a difference between the set of execution characteristics and a target configuration for the first process in Block S132; and, in response to detecting the difference between the set of execution characteristics and the target configuration for the first process, transmit a checkpoint command to the checkpoint program in Block S136.

In one example, the checkpoint server: receives the set of execution characteristics representing a first processor utilization by the first process at a target time; detects a quiescent (or idle) state of the first process in response to the first processor utilization falling below a threshold processor utilization (e.g., defined by the target configuration); and transmits the checkpoint command to the checkpoint program in response to detecting the quiescent state of the first process.

In another example, the checkpoint server: receives the set of execution characteristics representing a first memory utilization by the first process at a target time; detects the set of execution characteristics falling outside of the set of target performance characteristics represented by the target configuration in response to the first memory utilization exceeding a threshold memory utilization (e.g., defined by the target configuration); and transmits the checkpoint command to the checkpoint program in response to detecting the set of execution characteristics falling outside of the set of target performance characteristics represented by the target configuration.

Therefore, the system can: detect a deviation between target performance and actual performance of a process executing at a node; and automatically trigger real-time (or near-real-time) suspension of the process for resumption at a different node and/or at a later time in order to increase reliability of the process or a job including the process, to reduce a completion time of the process or the job, to reduce a total cost of completing a job including the process, and/or to execute load balancing across nodes in the cloud subsystem.

### 5.3 Checkpoint Object

Block S140 of the method S100 recites receiving the checkpoint command responsive to presence of a quiescent state of the first process represented by the set of execution characteristics.

Generally, in Blocks S140, S142, S144, and S146, in response to receiving a checkpoint command from the checkpoint server, the checkpoint program can: record a first state of the first process at a first time; generate a first checkpoint object representing the first state of the first process at the first time; and transmit the first checkpoint object to the checkpoint server.

In one implementation, in Block S140, the checkpoint program receives a checkpoint command from the checkpoint server.

For example, the checkpoint program can receive the checkpoint command responsive to a quiescent state (or an idle state) of the first process represented by the set of execution characteristics and/or detected by the checkpoint server.

In another implementation, in response to receiving a checkpoint command from the checkpoint server, the checkpoint program records the first state of the first process executing at the first node, the first state representing a first set of resources in the first node allocated to the first process at the first time in Block S142.

In one example, the checkpoint program can record the first state including a set of data stored in memory (e.g., processor registers, memory address space) of the first node and allocated to the first process.

In this example, the checkpoint program can record the first state including: a first subset of data stored in a first set of processor registers in the first set of resources allocated to the first process; and a second subset of data stored in a first memory device (e.g., an L1 cache, an L2 shared memory) in the first set of resources allocated to the first process.

In another example, the checkpoint program can record the first state representing: a set of file descriptors associated with the first process; a set of file connections associated with the first process; and/or a set of network connections associated with the first process.

In another implementation, the checkpoint program: generates a first checkpoint object representing the first state of the first process at the first time in Block S144; and transmits the first checkpoint object to the checkpoint server (and/or another data repository) in Block S146.

Additionally, the checkpoint program can: encrypt and/or compress the first checkpoint object; and then transmit the first checkpoint object to the checkpoint server.

In one variation, the checkpoint program: records the first state of the first process in Block S142; and streams the first state of the first process to the checkpoint server (and/or another data repository) to generate the first checkpoint object in Block S144.

Therefore, by streaming the first state of the first process directly to the checkpoint server (or the other data repository), the checkpoint program can reduce memory overhead attributed to generating (e.g., writing) the first checkpoint object in storage (e.g., disk) at the first node prior to transmitting the first checkpoint object to the checkpoint server.

Additionally or alternatively, the checkpoint program can stream the first state of the first process to a data repository proximal (e.g., geographically) a target node at which: the first state of the first process is to be restored; and execution of the first process is to be resumed, thereby reducing download latency of the first checkpoint object for the target node.

In another implementation, in Block S148, the system can: terminate execution of the first process and the first checkpoint program at the first node; and release resources allocated to the first process.

### 6. PROCESS RESUMPTION

The method S100 includes: instantiating the second checkpoint program at the second node in Block S102; and attaching the second checkpoint program to the first process in Block S104.

The method S100 includes: accessing the first checkpoint object from the checkpoint server in Block S150; extracting the first set of data and the second set of data from the first checkpoint object in Block S152; and restoring the first state of the first process at the second node in Block S154.

More specifically, the method S100 includes: restoring the first state of the first process at the second node by loading the first set of data into a second set of processor registers in the second node in Block S156; and loading the second set of data into a second memory device in the second node in Block S158.

Block S174 recites executing the first process at the second node based on the first set of data loaded into the second set of processor registers and the second set of data loaded into the second memory device.

Generally, as shown in FIG. 2B and in Blocks S150, S152, S154, S156, S158, and S174, the system can: select a target node (e.g., the first node, a second node different from the first node) in the set of nodes at which to schedule execution of the first process; transmit the first checkpoint object representing the first state of the first process at the first time to the target node; restore the first state of the first process at the target node; schedule execution of the first process at the target node; and resume execution of the first process at the target node.

### 6.1 Node Selection

In one implementation, during a second time period succeeding the first time period, the cloud orchestrator executes the foregoing methods and techniques: to select the target node at which to schedule the first process of the job; to instantiate a checkpoint program at the target node; and to attach the checkpoint program at the target node.

In one example, the cloud orchestrator executes the foregoing methods and techniques: to access performance characteristics of the set of nodes during the second time period; and to select the first node at which to schedule the first process in response to detecting correspondence between a second set of performance characteristics of the first node and the target configuration for the first process.

In another example, the cloud orchestrator executes the foregoing methods and techniques: to access performance characteristics of the set of nodes during the second time period; and to select the second node—different from the first node—at which to schedule the first process in response to detecting correspondence between a third set of performance characteristics of the second node and the target configuration for the first process.

In another example, the cloud orchestrator: calculates a first cost of resources on the first node to execute the first process during the second time period; calculates a second cost of resources on the second node to execute the first process during the second time period; and selects the second node for execution of the first process in response to the second cost falling below the first cost.

### 6.2 Checkpoint Object Access

In another implementation, in Block S150, the checkpoint program accesses the first checkpoint object from the checkpoint server (or another data repository).

For example, the checkpoint program can execute the foregoing methods and techniques to query the checkpoint server for a checkpoint object associated with the first process identifier identifying the first process.

In this example, the checkpoint server can: select the first checkpoint object stored in the data repository; and transmit the first checkpoint object to the target node.

Additionally or alternatively, in response to receiving the query for a checkpoint object associated with the process identifier, the checkpoint server can: generate a message indicating a location (e.g., an address) at which the first checkpoint object associated with the first process identifier is stored and accessible; and transmit the message to the checkpoint program.

The checkpoint program can then retrieve (e.g., download) the first checkpoint object from the location in response to receiving the message from the checkpoint server.

Additionally, the checkpoint program can decompress and/or decrypt the first checkpoint object.

### 6.2 State Restoration

In another implementation, in response to accessing the first checkpoint object, the checkpoint program restores the first state of the first process—represented in the first checkpoint object—at the target node in Block S154.

More specifically, the checkpoint program can: extract the set of data—recorded from memory of the first node at the first time—from the first checkpoint objects; restore the set of data into memory (e.g., processor registers, memory address space) of the target node; restore the set of file descriptors associated with the first process at the target node; restore the set of file connections associated with the first process at the target node; and/or restore the set of network connections associated with the first process at the target node; etc.

For example, the checkpoint program can: extract the first subset of data—recorded from the first set of processor registers of the first node allocated to the first process at the first time—from the first checkpoint object in Block S152; and load the first set ofdata into a second set ofprocessor registers in the target node in Block S156.

Additionally, the checkpoint program can: extract the second subset of data—recorded from the first memory device of the first node allocated to the first process at the first time—from the first checkpoint object in Block S152; and load the second set of data into a second memory device (e.g., an L1 cache, an L2 shared memory) in the target node in Block S158.

The target node can then resume execution of the first process in Block S174.

For example, the target node can resume execution of the first process based on the first set of data loaded into the second set of processor registers and the second set of data loaded into the second memory device in the target node.

Accordingly, the system can: suspend execution of a process of a job—such as an inference job—at a node at a first time, such as when user demand for inference falls below a demand threshold and/or other conditions (e.g., when resource utilization by the process falls below a utilization threshold, when a cost per unit of resource on the node exceeds a cost threshold); encapsulate a state of the process into a checkpoint object; and release the resources of the node allocated to the process in order to comply with a policy (e.g., a service level agreement, a target configuration) and/or to suspend ongoing cost accumulation attributed to the inference job.

Then, at a second time succeeding the first time—such as when user demand for inference exceeds the demand threshold and/or other conditions (e.g., when a cost per unit of resource on a target node falls below the cost threshold)—the system can: retrieve the checkpoint object; restore the state of the process onto resources of the target node; and resume execution from a point at which the process is suspended.

Therefore, the system can selectively suspend and resume execution of the process according to: time-varying resource utilization by the process; time-varying user demand for a result (e.g., an inference result) yielded by a job including the process; and/or time-varying availability or cost of node resources, thereby enabling more efficient allocation of node resources and reducing a total cost to complete the job while maintaining service level agreements.

### 6.3 Second Checkpoint

As shown in FIGS. 1 and 2C, the system can execute the foregoing methods and techniques: to monitor execution of the first process at the target node; to derive a second set of execution characteristics—representing execution of the first process on the target node—to the cloud orchestrator and/or the checkpoint server; to generate a second checkpoint command based on the second set of execution characteristics; to record a second state of the first process executing at the target node, the second state representing a second set of resources in the target node allocated to the first process at a second time in response to the second checkpoint command; to generate a second checkpoint object representing the second state of the first process at the second time; and to store the second checkpoint object at the checkpoint server (or another data repository).

In one example, the checkpoint program at the target node records the second state including a second set of data stored in memory (e.g., processor registers, memory address space) of the first node and allocated to the first process at the second time.

In this example, the checkpoint program can record the second state including: a third subset of data stored in the second set of processor registers in the second set of resources allocated to the first process; and a fourth subset of data stored in the second memory device in the second set of resources allocated to the first process.

In another example, the checkpoint program can record the second state representing: a second set of file descriptors associated with the first process at the second time; a second set of file connections associated with the first process at the second time; and/or a second set of network connections associated with the first process at the second time.

### 6.3.1 State Differential

Block S180 of the method S100 recites calculating a difference between the second state of the first process and the first state of the first process.

In one variation, the system can: calculate a differential (or “diff”) between the second state of the first process and the first state of the first process in Block S180; and generate the second checkpoint object representing the differential in Block S144.

More specifically, the checkpoint program at the target node: calculates a difference between the second state of the first process and the first state of the first process in Block S180; and generates the second checkpoint object representing the difference between the second state of the first process and the first state of the first process in Block S144.

In one example, the checkpoint program at the target node: calculates a first difference between the third set of data stored in the second set of processor registers and the first set of data extracted from the first checkpoint object; calculates a second difference between the fourth set of data stored in the second memory device and the second set of data extracted from the first checkpoint object; and generates the second checkpoint object representing the first difference and the second difference.

In another example, the checkpoint program at the target node: calculates a first difference between the second set of file descriptors associated with the first process at the second time and the set of file descriptors represented in the first checkpoint object; calculates a second difference between the second set of file connections associated with the first process at the second time and the set of file connections represented in the first checkpoint object; calculates a third difference between the second set of network connections associated with the first process at the second time and the set of network connections represented in the first checkpoint object; and generates the second checkpoint object representing the first difference, the second difference, and the third difference.

Accordingly, by generating the second checkpoint object representing the difference between the second state and the first state, the system can reduce a size of the second checkpoint object, thereby reducing communication overhead to communicate the second checkpoint object—and/or reducing overhead to store the second checkpoint object at the checkpoint server (or another data repository).

### 6.3 Subsequent Resumptions

The system can repeat the foregoing methods and techniques to suspend and/or resume execution of the first process on a node until completion of the first process.

For example, the checkpoint program can execute the foregoing methods and techniques: to select a second target node at which to schedule the first process of the job; to instantiate a checkpoint program at the second target node; to attach the checkpoint program at the second target node; and to access the first checkpoint object and the second checkpoint object by querying the checkpoint server for a checkpoint object associated with the first process.

In this example, the checkpoint program can sequentially: restore the first state of the first process represented by the first checkpoint object; and restore the second state of the first process based on the second checkpoint object representing the difference between the second state of the first process and the first state of the first process.

The system can repeat the foregoing methods and techniques for each process, in the set of processes, until completion of the job.

### 6.4 Checkpoint Timestamp

In one implementation, the system generates a checkpoint object characterized by a timestamp.

In this implementation, the checkpoint server stores a group of checkpoint objects associated with a process, each process characterized by a different timestamp. The checkpoint server can: receive a request for a checkpoint object characterized by a particular timestamp; select a sequence of checkpoint objects—in the group of checkpoint objects—from an initial checkpoint object to a target checkpoint object characterized by the particular timestamp; and return the sequence of checkpoint objects to a target node.

Then, the target node can execute the foregoing methods and techniques: to restore an initial state of the process represented by the initial checkpoint object; and, for each other checkpoint object in the sequence of checkpoint objects (e.g., excluding the initial checkpoint object), to sequentially restore a state of the process based on the checkpoint object representing a difference between the state of the process and a preceding state of the process.

### 7. CONTAINER CHECKPOINTING

The method S100 includes, at a first checkpoint program executing at a first node: deriving a set of execution characteristics representing resources in the first node allocated to a first process during execution of the first process within a first container instantiated at the first node in Block S112; and transmitting the set of execution characteristics to the checkpoint server in Block S114.

The method S100 also includes, at the first checkpoint program, in response to receiving the first checkpoint command from a checkpoint server: recording a first state of the first process executing within the first container at the first node, the first state representing a first set of resources in the first node assigned to the first container and allocated to the first process at a first time in Block S142; generating a first checkpoint object representing the first state of the first process at the first time in Block S146; and transmitting the first checkpoint object to the checkpoint server in Block S148.

The method S100 further includes, at a second checkpoint program executing at a second node: accessing the first checkpoint object from the checkpoint server in Block S150; extracting the first set of data from the first checkpoint object in Block S152; restoring the first state of the first process at the second node by loading the first set of data into a second memory in the second node for execution of the first process within a second container instantiated at the second node in Block S154; generating a message triggering resumption of the first process within the second container in Block S170; and transmitting the message to a container manager executing at the second node in Block S172.

Generally, the system can instantiate a container—representing an isolated runtime environment—at a node. The node can include a container manager (e.g., a container controller, a container daemon): that manages a set of containers in the node; and that interfaces between a container, in the set of containers, and a host operating system kernel of the node.

The system can execute the foregoing methods and techniques: to select a first node at which to schedule the first process; to instantiate a first container at the first node; to instantiate a first checkpoint program at the first node; to allocate resources in the first node to the first container and/or the first process; to schedule execution of the first process within the first container at the first node; and to execute the first process within the first container.

In one implementation, the first checkpoint program executes the foregoing methods and techniques: to monitor execution of the first process within the first container instantiated at the first node in Block S110; to derive a set of execution characteristics representing resources in the first node allocated to the first container and/or the first process during execution in Block S112; and to transmit the set of execution characteristics to the checkpoint server in Block S114.

For example, the first checkpoint program can monitor execution of the first process within the first container by querying the container manager for execution characteristics associated with the first process (e.g., according to the first process identifier).

In another implementation, during a first time period, the first checkpoint program executes the foregoing methods and techniques: to receive a checkpoint command from the checkpoint server in Block S140; to record a first state of the first process executing within the first container at the first node, the first state representing a first set of resources in the first node assigned to the first container and allocated to the first process at a first time in Block S142.

In one example, the first checkpoint program can record the first state including a first set of data stored in a first memory (e.g., processor registers, memory address space) in the first set of resources assigned to the first container and allocated to the first process at the first time.

In this example, the first checkpoint program can record the first state including: a first subset of data stored in a first set of processor registers in the first set of resources assigned to the first container and allocated to the first process; and a second subset of data stored in a first memory device (e.g., an L1 cache, an L2 shared memory) in the first set of resources assigned to the first container and allocated to the first process.

In this implementation, the first checkpoint program can execute the foregoing methods and techniques: to generate a first checkpoint object representing the first state of the first process at the first time in Block S144; and to transmit the first checkpoint object to the checkpoint server (and/or another data repository) in Block S146.

The system can then terminate execution of the first process, the first checkpoint program, and/or the first container at the first node; and release the resources allocated to the first process, the first checkpoint program, and/or the first container.

In another implementation, during a second time period succeeding the first time period, the system can execute the foregoing methods and techniques: to select a target node (e.g., the first node, a second node different from the first node) in the set of nodes at which to schedule execution of the first process; to instantiate a second container at the target node; and to instantiate a second checkpoint program at the target node.

In this implementation, the second checkpoint program: accesses the first checkpoint object from the checkpoint server (or another data repository) in Block S150; and restores the first state of the first process—represented in the first checkpoint object—at the target node in Block S154.

More specifically, the second checkpoint program can: extract the first set of data from the first checkpoint object in Block S152; and restore the first state of the first process at the target node by loading the first set of data into a second memory in the target node for execution of the first process within a second container instantiated at the second node in Block S154.

For example, the second checkpoint program can: extract the first subset of data—recorded from the first set of processor registers of the first node allocated to the first process at the first time—from the first checkpoint object in Block S152; and load the first set of data into a second set of processor registers in the target node and assigned to the second container in Block S156.

Additionally, the second checkpoint program can: extract the second subset of data—recorded from the first memory device of the first node allocated to the first process at the first time—from the first checkpoint object in Block S152; and load the second set of data into a second memory device (e.g., an L1 cache, an L2 shared memory) in the target node and assigned to the second container in Block S158.

In another implementation, the second checkpoint program: generates a message triggering resumption of the first process within the second container in Block S170; and transmits the message to a container manager executing at the target node in Block S172.

The target node can then resume execution of the first process within the second container at the target node in Block S174.

Therefore, the system can automatically suspend a process executing within a container in real-time (or near-real-time)—without modification to the process or the container—for resumption within a container instantiated at a different node and/or at a later time, thereby enabling more efficient allocation of node resources and/or reducing a total cost of completing a job including the process.

### 7.1 Nested Virtualization

In one variation, the system executes the foregoing methods and techniques: to select a first node at which to schedule the first process; to execute a first virtual machine in a first set of virtual machines at the first node; to instantiate a first container in the first virtual machine; to instantiate a first checkpoint program at the first node; to allocate resources in the first virtual machine to the first container and/or the first process; to schedule execution of the first process within the first container—and the first virtual machine—at the first node; and to execute the first process within the first container.

In this variation, the first checkpoint program executes the foregoing methods and techniques: to monitor execution of the first process within the first container in Block S110; and to derive a set of execution characteristics representing resources in the first node allocated to the first container and/or the first process during execution in Block S112.

In one example, the first checkpoint program queries a first guest operating system kernel of the first virtual machine for execution characteristics associated with the first process.

In another example, the first checkpoint program queries a first hypervisor controlling the first set of virtual machines for execution characteristics associated with the first process.

The first checkpoint program can then transmit the set of execution characteristics to the checkpoint server in Block S114.

In this variation, during a first time period, the first checkpoint program executes the foregoing methods and techniques: to receive a checkpoint command from the checkpoint server in Block S140; to record a first state of the first process executing within the first container in the first virtual machine at the first node, the first state representing a first set of resources in the first node assigned to the first container (and the first virtual machine) and allocated to the first process at a first time in Block S142.

In one example, the first checkpoint program can record the first state including a first set of data stored in a first memory (e.g., processor registers, memory address space) in the first set of resources—assigned to the first virtual machine and the first container—allocated to the first process at the first time.

In this example, the first checkpoint program can record the first state including: a first subset of data stored in a first set of processor registers in the first set of resources assigned to the first container and allocated to the first process; and a second subset of data stored in a first memory device (e.g., an L1 cache, an L2 shared memory) in the first set of resources—assigned to the first virtual machine and the first container—allocated to the first process.

In this implementation, the first checkpoint program can execute the foregoing methods and techniques: to generate a first checkpoint object representing the first state of the first process at the first time in Block S144; and to transmit the first checkpoint object to the checkpoint server (and/or another data repository) in Block S146.

The system can then: terminate execution of the first process, the first checkpoint program, the first container, and/or the first virtual machine at the first node; and release the resources allocated to the first process, the first checkpoint program, the first container, and/or the first virtual machine at the first node.

In another variation, during a second time period succeeding the first time period, the system can execute the foregoing methods and techniques: to select a target node (e.g., the first node, a second node different from the first node) in the set of nodes at which to schedule execution of the first process; to execute a second virtual machine in a second set of virtual machines at the target node; to instantiate a second container in the second virtual machine; and to instantiate a second checkpoint program at the target node.

In this variation, the second checkpoint program: accesses the first checkpoint object from the checkpoint server (or another data repository) in Block S150; and restores the first state of the first process—represented in the first checkpoint object—at the target node in Block S54.

More specifically, the second checkpoint program can: extract the first set of data from the first checkpoint object in Block S152; and restore the first state of the first process at the target node by loading the first set of data into a second memory in the target node for execution of the first process within a second container instantiated in the second virtual machine at the second node in Block S154.

For example, the second checkpoint program can: extract the first subset of data—recorded from the first set of processor registers of the first node allocated to the first process at the first time—from the first checkpoint object in Block S152; and load the first set of data into a second set of processor registers in the target node and assigned to the second container (and the second virtual machine) in Block S156.

Additionally, the second checkpoint program can: extract the second subset of data—recorded from the first memory device of the first node allocated to the first process at the first time—from the first checkpoint object in Block S152; and load the second set of data into a second memory device (e.g., an L1 cache, an L2 shared memory) in the target node and assigned to the second container (and the second virtual machine) in Block S158.

In another implementation, the second checkpoint program: generates a message triggering resumption of the first process within the second container in Block S170; and transmits the message to a container manager executing at the target node in Block S172.

The target node can then resume execution of the first process within the second container in the second virtual machine executing at the target node in Block S174.

### 8. GRAPHICS PROCESSING UNIT CHECKPOINTING

The method S100 includes: intercepting a first call in a set of calls to a first application programming interface of a first graphics processing unit in the first node by the first process in Block S120; detecting a first subset of memory operations, associated with the first call, in a first set of memory operations associated with the first graphics processing unit in Block S122; and generating a first call record, in a set of call records, representing the first call and the first subset of memory operations in Block S124.

As described herein, the system executes Blocks of the method S100: to monitor execution of a process on a central processing unit of a node; to record a state of the process in response to receiving a checkpoint command; to later restore the state of the process on a target node; and to resume execution of the process on a target central processing unit of the target node.

However, in the system can similarly execute Blocks of the method S100: to monitor execution of a process on a central processing unit and/or a graphics processing unit(s) of a node; to record a state of the process in response to receiving a checkpoint command; to later restore the state of the process on a target node; and to resume execution of the process on a target central processing unit and/or a target graphics processing unit(s) of the target node.

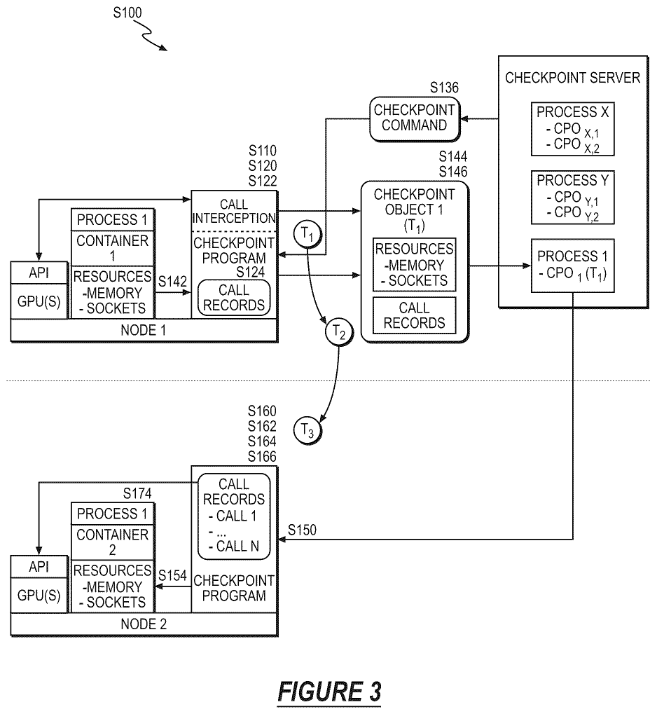

Generally, as shown in FIG. 3 and in Blocks S120, S122, and S124, the checkpoint program can track a set of calls—by a process executing on a central processing unit of a node—to an application programming interface (e.g., a runtime application programming interfacing, a driver application programming interfacing) of a graphics processing unit (or a set of graphics processing units) of the node. For each call in the set of calls, the checkpoint program can: intercept the call to the application programming interface of the graphics processing unit; generate a call record—in a set of call records—representing the call; and pass the call to a controller of the graphics processing unit for execution.

Accordingly, in response to receiving a checkpoint command, the checkpoint program can: access the set of call records; generate a checkpoint object representing a state of the process—and a state of the graphics processing unit—based on the set of call records; and store the checkpoint object for later retrieval. Therefore, the system can later: access the checkpoint object representing the state of the process based on the set of call records; and execute (or “replay”) the set of calls represented in the set of call records in order to restore the state of the graphics processing unit(s) at the target node.

### 8.1 Graphics Processing Unit Application Programming Interface Calls

In one implementation, the checkpoint program executing at the first node: tracks a set of calls by the first process to a first application programming interface (e.g., a runtime application programming interface) of a first graphics processing unit in the first node; and tracks a set of memory operations (storage of data onto graphics processing unit memory, release of data from graphics processing unit memory)—associated with the first process—between a first central processing unit and the first graphics processing unit of the first node.

For example, the checkpoint program can: intercept a first call to the runtime application programming interface of the first graphics processing unit by the first process in Block S120; detect a first subset of memory operations associated with the first call in Block S122; and generate a first call record representing the first call and the first subset of memory operations in Block S124.

More specifically, the checkpoint program can store the first call, the first subset of memory operations, and/or the first call record in a shared memory segment accessible by a remote procedure call server communicatively coupled to the checkpoint program. Therefore, rather than transmitting the first call to the remote procedure call (or “RPC”) server via Transmission Control Protocol/Internet Protocol (or “TCP/IP”), the system can pass the first call between the checkpoint program and the remote procedure call server via the shared memory segment, thereby reducing latency between successive calls.

The checkpoint program can pass the first call to a first controller of the first graphics processing unit for execution.

The checkpoint program can repeat the foregoing methods and techniques for each call to the first application programming interface of the first graphics processing unit (and/or to an application programming interface(s) of another graphics processing unit(s)) during execution of the first process to generate a set of call records representing: the set of calls by the first process during a first time period; and the set of memory operations associated with the set of calls.

Then, in response to receiving a checkpoint command, the checkpoint program can: generate the first checkpoint object representing the first state of the first process executing at the first node, the first state representing the set of call records in Block S144; and transmit the checkpoint object to the checkpoint server in Block S146.

### 8.1.1 Selected Application Programming Interface Calls

In one variation, the checkpoint program selectively intercepts a call to the first application programming interface of the first graphics processing unit based on a call type of the call.

For example, the checkpoint program can selectively intercept a call to the first application programming interface of the first graphics processing unit in response to the call exhibiting a first call type in a set of target call types (e.g., based on a process type of the first process, based on a job type of the job).

Accordingly, by selectively intercepting calls to the first application programming interface of the first graphics processing unit, the system can thereby: reduce disk write overhead to generate call records; reduce execution time to complete the first process; and reduce a size of the first checkpoint object representing the set of call records.

### 8.2 Process Resumption

The method S100 includes: extracting the set of call records from the first checkpoint object in Block S160; identifying the set of calls and the set of memory operations based on the set of call records in Block S162; executing the set of calls to the application programming interface of the first graphics processing unit in the first node in Block S164; and executing the set of memory operations in association with the first graphics processing unit in Block S166.

In one implementation, the system executes the foregoing methods and techniques: to select a target node (e.g., the first node, a second node different from the first node) in the set of nodes at which to schedule execution of the first process; to instantiate a checkpoint program at the target node; to access the first checkpoint object; and to restore the first state of the first process—represented in the first checkpoint object—at the target node.

In this implementation, the system: extracts the set of call records from the first checkpoint object in Block S160; identifies the set of calls and the set of memory operations based on the set of call records in Block S162; executes the set of calls to a second application programming interface(s) of a second graphics processing unit(s) in the target node in Block S164; and executes the set of memory operations in association with the second graphics processing unit(s) in Block S166.

For example, the system can: identify a first subset of synchronous calls in the set of calls; identify a second subset of asynchronous calls in the set of calls; sequentially execute the first subset of synchronous calls to the second application programming interface of the second graphics processing unit; and batch executing the second subset of asynchronous calls to the second application programming interface.

Additionally, the checkpoint program can execute the foregoing methods and techniques: to extract the set of data—recorded from memory of the first node at the first time—from the first checkpoint objects; to restore the set of data into memory (e.g., processor registers, memory address space) of the target node; to restore the set of file descriptors associated with the first process at the target node; to restore the set of file connections associated with the first process at the target node; and/or to restore the set of network connections associated with the first process at the target node; etc.

Then, the target node can resume execution of the first process in response to: execution of the set of calls to the second application programming interface of the second graphics processing unit; and execution of the set of memory operations associated with the second graphics processing unit.

### 8.3 Example: Inference Job Checkpointing

In one example, during a first time period, the system: selects a first node at which to schedule a first process of an inference job; instantiates a first container at the first node; instantiates a first checkpoint program at the first node; executes the first process within the first container; and monitors execution of the first process.

More specifically, the first checkpoint program can: intercept a set of calls by the first process to a first application programming interface of a first graphics processing unit in the first node and assigned to the first container; detect a set of memory operations associated with the set of calls; and generate a set of call records representing the set of calls and the set of memory operations.

Additionally, the first checkpoint program can: derive a set of execution characteristics representing a first processor utilization and/or a first graphics processing unit utilization by the first process; and transmit the set of execution characteristics to the checkpoint server.

In response to receiving a checkpoint command responsive to the first processor utilization and/or the first graphics processing unit utilization falling below a utilization threshold(s) (e.g., representing an idle state of the first process and/or an interval of relatively low demand for inference), the first checkpoint program records a first state of the first process executing at the first node, the first state: representing a set of resources allocated to the first process at a first time; including a set of data—stored in memory (e.g., process registers, memory address space) of the first node—representing an architecture (e.g., a set of layers) of a model (e.g., a large language model) and a set of parameters (e.g., weights) associated with the model; and representing the set of call records at the first time.

Additionally or alternatively, the set of call records can indicate the set of memory operations associated with the set of calls and representing the architecture of the model loaded into and/or the set of parameters associated with the model.

In this example, the first checkpoint program: generates a first checkpoint object representing the first state of the first process at the first time; and transmits the first checkpoint object to the checkpoint server. The system: terminates execution of the first process, the first checkpoint program, and/or the first container at the first node; and releases resources allocated to the first process, the first checkpoint program, and/or the first container.

Therefore, the system can: initialize and/or configure the model associated with the first process at the first node; suspend execution of the first process of the inference job when resource utilization by the first process falls below a utilization threshold and/or when user demand for inference falls below a demand threshold; encapsulate the first state of the first process—after initialization and/or configuration of the model—into the first checkpoint object for later resumption; and release resources of the first node allocated to the first process in order to more efficiently allocate node resources and/or to reduce a total cost attributed to the inference job.

### 8.3.1 Example: Inference Job Resumption

In another example, during a second time period—characterized by relatively high user demand for inference—succeeding the first time, the system: selects a target node at which to schedule the first process of the inference job; instantiates a second container at the target node; and instantiates a second checkpoint program at the target node.

In this example, the second checkpoint program: accesses the first checkpoint object from the checkpoint server (or another data repository); and restores the first state of the first process—recorded after initialization and/or configuration of the model and represented in the first checkpoint object—at the target node.

More specifically, the second checkpoint program can: extract the set of data—representing the architecture of the model and the set of parameters associated with the model—from the first checkpoint object; and restore the first state of the first process at the target node by loading the set of data into a second memory (e.g., process registers, an L1 cache, an L2 shared memory) in the target node for execution of the first process within the second container.

Additionally, the second checkpoint program can: extract the set of call records from the first checkpoint object; identify the set of calls and the set of memory operations based on the set of call records; execute the set of calls to a second application programming interface(s) of a second graphics processing unit(s) in the target node; and execute the set of memory operations in association with the second graphics processing unit(s).

In particular, the second checkpoint program can execute memory operations in the set of memory operations that load the architecture of the model and/or the set of parameters associated with the model in memory of the second graphics processing unit.

The target node then resumes execution of the first process within the second container executing at the target node.

Accordingly, by restoring the first state of the first process—recorded after initialization and/or configuration of the model at the first node—at the target node, the system can: bypass initialization and/or configuration of the model (e.g., loading weights into memory from disk storage) at the target node; and/or automatically load memory of the second graphics processing unit with the architecture and/or the set of parameters (e.g., weights) associated with the model and represented in the first checkpoint object.

Therefore, the system can selectively suspend and resume execution of the first process in real-time (or near-real-time)—without initialization and/or configuration of the model at the target node prior to resuming execution of the first process—according to time-varying user demand for inference, thereby reducing a “time to first token” (and/or a “cold start time”) associated with the inference job and/or reducing a total cost to execute (or complete) the inference job according to service level agreements.

### 9. DISTRIBUTED CHECKPOINT

The method S100 includes: generating a command that causes a target group of processes to enter a quiescent state in Block S190; transmitting the command to the first checkpoint program and a second checkpoint program executing at the first node in Block S192; receiving a first message indicating the first process exhibiting a first quiescent state from the first checkpoint program in Block S194; receiving a second message indicating the second process exhibiting a second quiescent state from the second checkpoint program in Block S196; and transmitting the first checkpoint command to a first checkpoint queue of the first checkpoint program in response to presence of the first quiescent state of the first process and the second quiescent state of the second process in Block S136.

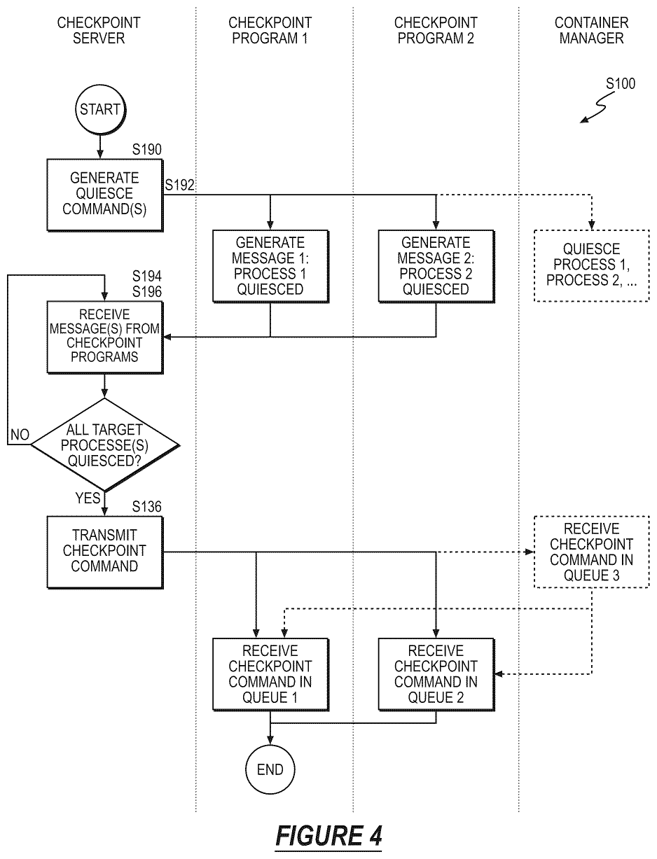

In one implementation, as shown in FIG. 4, the system concurrently executes a target group of processes (e.g., interdependent processes)—and a group of checkpoint programs attached to the target group of processes—at a group of nodes in the set ofnodes.

For example, the system can: execute a first process in the target group of processes within a first container executing at a first node in the group of nodes; execute a second process in the target group of processes within a second container executing at the first node; execute a third process in the target group of processes at a second node in the group of nodes; instantiate a first checkpoint program and a second checkpoint program at the first node; instantiate a third checkpoint program at the second node; attach the first checkpoint program to the first process; attach the second checkpoint program to the second process; and attach the third checkpoint program to the third process.

In another implementation, the checkpoint server quiesces the target group of processes for a target time interval (or a “quiescent interval”).

More specifically, the checkpoint server: generates a command that causes the target group of processes to enter a quiescent state in Block S190; and transmits the command to the group of checkpoint programs (e.g., the first checkpoint program, the second checkpoint program, the third checkpoint program) in Block S192.

The checkpoint server can: receive a first message indicating the first process exhibiting a first quiescent state from the first checkpoint program in Block S194; and receive a second message indicating the second process exhibiting a second quiescent state from the second checkpoint program in Block S196. Additionally, the checkpoint server can receive a message—from each process in the target group of processes—indicating the process exhibiting a quiescent state.

In response to detecting the target group of processes exhibiting a quiescent state (e.g., the first quiescent state of the first process, the second quiescent state of the second process), the checkpoint server can: transmit a first checkpoint command to a first checkpoint queue of the first checkpoint program in Block S136; and transmit the first checkpoint command to a second checkpoint queue of the second checkpoint program.

The checkpoint server can repeat the foregoing methods and techniques for each process in the target group of processes to transmit the first checkpoint command to a checkpoint queue of a checkpoint program attached to the process in response to detecting the target group of processes exhibiting a quiescent state.

Therefore, the system can quiesce the target group of processes prior to transmitting a checkpoint command—to checkpoint queues of the group of checkpoint programs—to record a set of states of the target group of processes in order to ensure synchronization and/or consistency between states in the set of states.

In one variation, the checkpoint server transmits the first checkpoint command to a checkpoint queue at a container manager controlling the first container and the second container.

In this variation, the container manager routes the first checkpoint command to the first checkpoint queue at the first checkpoint program and the second checkpoint queue at the second checkpoint program.

In another variation, the cloud orchestrator executes the foregoing methods and techniques to quiesce the target group of processes for a target time interval by: generating a command that causes the target group of processes to enter a quiescent state; and transmitting the command to each checkpoint program in the group of checkpoint programs. For each process in the target group of processes, the cloud orchestrator receives a message indicating the process exhibiting a quiescent state from a checkpoint program—in the group of checkpoint programs—attached to the process.

In response to detecting the target group of processes exhibiting a quiescent state, the cloud orchestrator transmits a request to the checkpoint server to checkpoint the target group of processes during the target time interval.

In response to receiving the request to checkpoint the target group of processes during the target time interval, the checkpoint server executes the foregoing methods and techniques—for each process in the target group of processes—to transmit a first checkpoint command to a checkpoint queue of a checkpoint program attached to the process.

### 9.1 Checkpoint Objects

Generally, the system can execute the foregoing methods and techniques to record a state of a process in the target group of processes in response to receiving a checkpoint command.

In one implementation, during the target time interval, the first checkpoint program executes the foregoing methods and techniques: to receive the first checkpoint command in the first checkpoint queue; to record a first state—representing a first set of resources in the first node assigned to the first container and allocated to the first process at a first time within the target time interval—of the first process in response to receiving the first checkpoint command; to generate a first checkpoint object representing the first state of the first process; and to transmit the first checkpoint object to the checkpoint server.

In another implementation, during the first time interval, the second checkpoint program executes the foregoing methods and techniques: to receive the first checkpoint command in the second checkpoint queue; to record a second state—representing a second set of resources in the first node assigned to the second container and allocated to the second process at a second time within the target time interval—of the second process in response to the first checkpoint command; to generate a second checkpoint object representing the second state of the second process; and to transmit the second checkpoint object to the checkpoint server.

The system can repeat the foregoing methods and techniques for each process in the target group ofprocesses.

For example, the third checkpoint program executes the foregoing methods and techniques: to receive the first checkpoint command in a checkpoint queue of the third checkpoint program; to record a third state—representing a third set of resources in second first node allocated to the third process at a third time within the target time interval—of the second process in response to the first checkpoint command; to generate a third checkpoint object representing the third state of the third process; and to transmit the third checkpoint object to the checkpoint server.

Therefore, the system can: concurrently suspend execution of a target group of processes at a group of nodes; record states of the target group of processes via a distributed (or “global”) checkpoint command; generate a group of checkpoint objects representing the states of the target group of processes; and store the group of checkpoint objects for later retrieval and resumption of the target group of processes.

For example, the system can execute the foregoing methods and techniques: to select a second group of nodes at which to schedule the target group of processes; to access the group of checkpoint objects at the second group of nodes; to restore the states of the target group of processes onto resources of the second group of nodes; and to resume execution of the target group of processes.

### 9.1 Example: Network Throughput

In one example, the system: executes a first process—in a target group of processes—within a first container executing at a first node in a first computer network (e.g. a first network fabric); executes a second process in the target group of processes within a second container executing at the first node; executes a third process in the target group of processes within a third container at a second node in the first computer network; instantiate a first checkpoint program and a second checkpoint program at the first node; instantiate a third checkpoint program at the second node; attach the first checkpoint program to the first process; attach the second checkpoint program to the second process; and attach the third checkpoint program to the third process.

In this example, the third checkpoint program the foregoing methods and techniques: to monitor execution of the third process within the third container at the third node; to derive a set of execution characteristics representing resources in the second node assigned to the third container and allocated to the third process during execution; and to transmit the set of execution characteristics to the checkpoint server.

More specifically, the third checkpoint program derives the set of execution characteristics representing a third network throughput allocated to the third process during execution at the third node in the first computer network.

In response to receiving the set of execution characteristics from the third checkpoint program, the checkpoint server: accesses a target configuration for the third process representing a target network throughput range (and/or network throughput threshold); and detects a difference between the set of execution characteristics and the target configuration for the third process in response to detecting the third network throughput exceeding the target network throughput range (and/or network throughput threshold).

In response to detecting the difference between the set of execution characteristics and the target configuration for the third process, the checkpoint server: generates a command that causes the target group of processes to enter a quiescent state; and transmits the command to the first checkpoint program, the second checkpoint program, and the third checkpoint program.

The checkpoint server: receives a first message indicating the first process exhibiting a first quiescent state from the first checkpoint program; receives a second message indicating the second process exhibiting a second quiescent state from the second checkpoint program; and receives a third message indicating the third process exhibiting a third quiescent state from the third checkpoint program.

In response to detecting the target group of processes exhibiting a quiescent state (e.g., the first quiescent state of the first process, the second quiescent state of the second process, the third quiescent state of the third process), the checkpoint server: transmits a first checkpoint command to a first checkpoint queue of the first checkpoint program; transmits the first checkpoint command to a second checkpoint queue of the second checkpoint program; and transmits the first checkpoint command to a third checkpoint queue of the third checkpoint program.

In this example, the third checkpoint program executes the foregoing methods and techniques: to receive the first checkpoint command in the third checkpoint queue; to record a third state—representing a third set of resources in the second node assigned to the third container and allocated to the third process at a third time within the target time interval—of the third process in response to receiving the first checkpoint command; to generate a third checkpoint object representing the third state of the third process; and to transmit the third checkpoint object to the checkpoint server (or another data repository).

The system can repeat the foregoing methods and techniques to generate a first checkpoint object—representing a first state of the first process within the first container at the first node—and a second checkpoint object representing a second state of the second process within the second container at the first node.

In this example, the system: terminates execution of the third process, third checkpoint program, and/or the third container at the second node; and releases resources allocated to the third process, third checkpoint program, and/or the third container.

The system then: selects a third node in a second computer network (e.g., a second network fabric) different from the first computer network; instantiates a fourth checkpoint program at the third node; and attaches the fourth checkpoint program to the third process.

In this example, the system: accesses the third checkpoint object; restores the third state of the first process onto resources assigned to a fourth container at the third node; and executes the third process within the fourth container.

Additionally, the system can resume execution of the first process and the second process at the first node.

Accordingly, by detecting the third network throughput by the third process exceeding the target network throughput range (and/or the network throughput threshold), the system can automatically: suspend execution of the first process, the second process, and the third process; record states of the first process, the second process, and the third process; migrate the third process from the second node in the first computer network to the third node in the second computer network; restore a state of the third process onto resources of the third node; and resume execution of the first process, the second process, and the third process.

Therefore, by migrating the third process to the third node in the second computer network different (e.g., separate) from the first computer network including the first node and the second node, the system can load balance network throughput for the first process, the second process, and the third process across nodes in the first computer network and the second computer network in order to mitigate risk of dropped network packets and/or failing to meet service level agreements for these processes.

### 10. CONCLUSION

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a first time period:
at a first checkpoint program executing at a first node, in response to receiving a first checkpoint command from a checkpoint server:
recording a first state of a first process executing at the first node, the first state:
representing a first set of resources in the first node allocated to the first process at a first time;
comprising a first set of data stored in a first set of processor registers in the first set of resources; and
comprising a second set of data stored in a first memory device in the first set of resources;
generating a first checkpoint object representing the first state of the first process at the first time; and
transmitting the first checkpoint object to the checkpoint server; and
terminating execution of the first process and the first checkpoint program at the first node; and
during a second time period succeeding the first time period:
at a second checkpoint program executing at a second node:
accessing the first checkpoint object from the checkpoint server;
extracting the first set of data and the second set of data from the first checkpoint object; and
restoring the first state of the first process at the second node by:
loading the first set of data into a second set of processor registers in the second node; and
loading the second set of data into a second memory device in the second node; and
resuming the first process at the second node based on the first set of data loaded into the second set of processor registers and the second set of data loaded into the second memory device.

2. The method of claim 1, further comprising, during the second time period, at the second checkpoint program executing at the second node, in response to receiving a second checkpoint command from the checkpoint server:
recording a second state of the first process executing at the second node, the second state:
representing a second set of resources in the second node allocated to the first process at a second time;
comprising a third set of data stored in the second set of processor registers in the second set of resources; and
comprising a fourth set of data stored in the second memory device in the second set of resources;
generating a second checkpoint object representing the second state of the first process at the second time; and
transmitting the second checkpoint object to the checkpoint server.

3. The method of claim 2, wherein generating the second checkpoint object comprises:
calculating a first difference between the third set of data stored in the second set of processor registers and the first set of data extracted from the first checkpoint object;
calculating a second difference between the fourth set of data stored in the second memory device and the second set of data extracted from the first checkpoint object; and
generating the second checkpoint object representing the first difference and the second difference.

4. The method of claim 1, further comprising:
during the second time period, at the second checkpoint program executing at the second node, in response to receiving a second checkpoint command from the checkpoint server:
recording a second state of the first process executing at the second node, the second state:
representing a second set of resources in the second node allocated to the first process at a second time;
comprising a third set of data stored in the second set of processor registers in the second set of resources; and
comprising a fourth set of data stored in the second memory device in the second set of resources;
calculating a difference between the second state of the first process and the first state of the first process;
generating a second checkpoint object representing the difference between the second state of the first process and the first state of the first process; and
transmitting the second checkpoint object to the checkpoint server; and
during third time period succeeding the second time period, at a third checkpoint program executing at a third node:
accessing the first checkpoint object and the second checkpoint object from the checkpoint server; and
restoring the second state of the first process at the third node by:
restoring the first state of the first process based on the first checkpoint object; and
restoring the second state of the first process based on the second checkpoint object representing the difference between the second state of the first process and the first state of the first process.

5. The method of claim 1:
further comprising:
intercepting a first call in a set of calls to a first application programming interface of a first graphics processing unit in the first node;
detecting a first subset of memory operations, in a set of memory operations, associated with the first call and the first graphics processing unit; and
generating a first call record, in a set of call records, representing the first call and the first subset of memory operations;
wherein recording the first state of the first process comprises recording the first state of the first process executing at the first node, the first state representing the first set of call records at the first time;
further comprising:
extracting the set of call records from the first checkpoint object; and
identifying the set of calls and the set of memory operations based on the set of call records;
wherein restoring the first state of the first process at the second node comprises:
executing the set of calls to a second application programming interface of a second graphics processing unit in the second node; and
executing the set of memory operations associated with the second graphics processing unit; and
wherein resuming the first process at the second node comprises resuming the first process at the second node in response to:
execution of the set of calls to the second application programming interface of the second graphics processing unit; and
execution of the set of memory operations associated with the second graphics processing unit.

6. The method of claim 5:
wherein identifying the set of calls comprises:
identifying a first subset of synchronous calls in the set of calls; and
identifying a second subset of asynchronous calls in the set of calls; and
wherein executing the set of calls comprises:
sequentially executing the first subset of synchronous calls to the second application programming interface; and
batch-executing the second subset of asynchronous calls to the second application programming interface.

7. The method of claim 5:
wherein intercepting the first call comprises selectively intercepting the first call characterized by a first call type in a set of target call types; and
wherein generating the first call record comprises storing the first call record in a shared memory segment accessible by a remote procedure call server communicatively coupled to the first node and the second node.

8. The method of claim 1, further comprising, during the first time period, at the first checkpoint program:
deriving a set of execution characteristics representing resources in the first node allocated to the first process during execution;
transmitting the set of execution characteristics to the checkpoint server; and
receiving the checkpoint command responsive to presence of a quiescent state of the first process represented by the set of execution characteristics.

9. The method of claim 8, further comprising, during the first time period, at the checkpoint server:
receiving the set of execution characteristics from the first checkpoint program, the set of execution characteristics representing a first processor utilization by the first process at a target time;
detecting the quiescent state of the first process in response to the first processor utilization falling below a threshold processor utilization; and
transmitting the checkpoint command to the first checkpoint program in response to detecting the quiescent state of the first process.

10. The method of claim 1:
wherein recording the first state of the first process comprises recording the first state of the first process executing within a first container representing an isolated runtime environment instantiated at the first node, the first state representing the first set of resources in the first node assigned to the first container and allocated to the first process at the first time;
wherein restoring the first state of the first process at the second node comprises restoring the first state of the first process at the second node by:
loading the first set of data into the second set of processor registers in the second node and assigned to a second container representing an isolated runtime environment instantiated at the second node; and
loading the second set of data stored in a second memory device in the second node and assigned to the second container; and
wherein resuming the first process at the second node comprises resuming the first process within the second container.

11. The method of claim 10:
further comprising querying a guest kernel of a first virtual machine executing at the first node for execution characteristics associated with the first process executing within the first container instantiated in the first virtual machine;
wherein recording the first state of the first process comprises recording the first state of the first process executing within the first container at the first virtual machine, the first state representing the first set of resources:
assigned to the first container;
assigned to the first virtual machine; and
allocated to the first process at the first time;
wherein loading the first set of data comprises loading the first set of data into the second set of processor registers assigned to the second container instantiated in a second virtual machine executing at the second node;
wherein loading the second set of data loading the second set of data stored into the second memory device assigned to the second container and the second virtual machine; and
wherein resuming the first process within the second container comprises executing the first process within the second container instantiated in the second virtual machine.

12. The method of claim 1:
wherein recording the first state of the first process comprises recording the first state of the first process executing at the first node, the first state representing:
a set of file descriptors associated with the first process;
a set of file connections associated with the first process; and
a set of network connections associated with the first process; and
wherein restoring the first state of the first process at the second node comprises:
restoring the set of file descriptors associated with the first process at the second node;
restoring the set of file connections associated with the first process at the second node; and
restoring the set of network connections associated with the first process at the second node.

13. The method of claim 1:
further comprising, during the first time period, at the first checkpoint program, receiving the first checkpoint command in a first checkpoint queue of the first checkpoint program;
wherein recording the first state of the first process comprises recording the first state of the first process executing at the first node, the first state representing the first set of resources in the first node allocated to the first process at the first time within a quiescent interval associated with a target group of processes comprising the first process and a second process; and
further comprising, at a third checkpoint program executing at a third node during the first time period:
receiving a second checkpoint command in a second checkpoint queue of the third checkpoint program from the checkpoint server; and
in response to receiving the second checkpoint command:
recording a second state of a second process, in a target group of processes, executing at the third node, the second state representing a second set of resources in the third node allocated to the second process at a second time within the quiescent interval;
generating a second checkpoint object representing the second state of the second process at the third time; and
transmitting the second checkpoint object to the checkpoint server.

14. The method of claim 1:
wherein recording the first state of the first process comprises recording the first state of the first process of an inference job executing at the first node, the first state comprising the second set of data representing a model architecture and a set of parameters associated with the model; and
wherein loading the second set of data comprises loading the second set of data representing the model architecture and the set of parameters associated with the model into the second memory device.

15. The method of claim 1:
further comprising, during the first time period:
instantiating the first checkpoint program at the first node, the first checkpoint program characterized as background process executing at the first node; and
attaching the first checkpoint program to the first process identified by a first process identifier;
further comprising, during the second time period:
instantiating the second checkpoint program at the second node; and
attaching the second checkpoint program to the first process; and
wherein accessing the first checkpoint object comprises and querying the checkpoint server for a checkpoint object associated with the first process identifier.

16. A method comprising:
during a first time period:
at a first checkpoint program executing at a first node:
deriving a set of execution characteristics representing resources in the first node allocated to a first process during execution of the first process within a first container instantiated at the first node; and
transmitting the set of execution characteristics to the checkpoint server;
at the checkpoint server:
in response to receiving the set of execution characteristics at the checkpoint server, detecting a difference between the set of execution characteristics and a target configuration for the first process; and
transmitting a first checkpoint command to the first checkpoint program in response to detecting the difference; and
at the first checkpoint program, in response to receiving the first checkpoint command from a checkpoint server:
recording a first state of the first process executing within the first container at the first node, the first state:
representing a first set of resources in the first node assigned to the first container and allocated to the first process at a first time; and
comprising a first set of data stored in a first memory in the first set of resources;
generating a first checkpoint object representing the first state of the first process at the first time; and
transmitting the first checkpoint object to the checkpoint server; and
during a second time period succeeding the first time period, at a second checkpoint program executing at a second node:
accessing the first checkpoint object from the checkpoint server;
extracting the first set of data from the first checkpoint object;
restoring the first state of the first process at the second node by loading the first set of data into a second memory in the second node for execution of the first process within a second container instantiated at the second node;
generating a message triggering resumption of the first process within the second container; and
transmitting the message to a container manager executing at the second node.

17. The method of claim 16, wherein transmitting the first checkpoint command comprises:
generating a command that causes a target group of processes to enter a quiescent state, the target group of processes comprising the first process and a second process executing within a second container instantiated at the first node;
transmitting the command to the first checkpoint program and a second checkpoint program executing at the first node, the second checkpoint program attached to the second process;
receiving a first message indicating the first process exhibiting a first quiescent state from the first checkpoint program;
receiving a second message indicating the second process exhibiting a second quiescent state from the second checkpoint program; and
transmitting the first checkpoint command to a first checkpoint queue of the first checkpoint program in response to presence of the first quiescent state of the first process and the second quiescent state of the second process.

18. The method of claim 16:
wherein deriving the set of execution characteristics comprises deriving the set of execution characteristics representing a first network throughput allocated to the first process during execution at the first node in a first computer network;
wherein detecting the difference between the set of execution characteristics and the target configuration for the first process comprises:
accessing the target configuration for the first process representing a target network throughput range; and
detecting the first network throughput exceeding the target network throughput range; and
wherein restoring the first state of the first process at the second node comprises restoring the first state of the first process at the second node in a second computer network different from the first computer network.

19. A method comprising, at a first checkpoint program executing at a first node during a first time period:
intercepting a first call in a set of calls to a first application programming interface of a first graphics processing unit in the first node by a first process at the first node;
detecting a first subset of memory operations, associated with the first call, in a first set of memory operations associated with the first graphics processing unit;
generating a first call record, in a set of call records, representing the first call and the first subset of memory operations; and
in response to receiving a checkpoint command from a checkpoint server:
recording a first state of the first process executing at the first node, the first state:
representing a first set of resources in the first node allocated to the first process at a first time;
comprising a first set of data stored in a first memory in the first set of resources; and
representing the set of call records at the first time;
generating a first checkpoint object representing the first state of the first process at the first time; and
transmitting the first checkpoint object to the checkpoint server.

20. The method of claim 19:
at the first checkpoint program executing at the first node during a second time period succeeding the first time period:
accessing the first checkpoint object from the checkpoint server;
extracting the first set of data from the first checkpoint object;
extracting the set of call records from the first checkpoint object;
identifying the set of calls and the set of memory operations based on the first set of call records; and
restoring the first state of the first process at the first node by:
loading the first set of data into the first memory in the first node;
executing the set of calls to the application programming interface of the first graphics processing unit in the first node; and
executing the set of memory operations in association with the first graphics processing unit; and
executing the first process at the first node based on the first set of data loaded into the first memory and in response to execution of the set of memory operations.
